(19) United States
(12) Patent Application Publication
(10) Pub. No.: US 2019/0084506 A1
(43) Pub. Date: Mar. 21, 2019

(54) POWER RECEPTACLE SYSTEM FOR AN AUTOMOTIVE VEHICLE

(71) Applicant: GM GLOBAL TECHNOLOGY OPERATIONS LLC, Detroit, MI (US)

(72) Inventor: Michael A. Gutierrez, Dearborn Heights, MI (US)

(21) Appl. No.: 15/705,707

(22) Filed: Sep. 15, 2017

(51) Int. Cl. B60R 16/03; F02D 41/02; H02K 5/22; H02K 7/00; H02K 11/33; H02K 11/35; H01R 24/78

(52) U.S. Cl. CPC B60R 16/03; F02D 41/021; H02K 5/225; H01R 2103/00; H02K 11/33; H02K 11/35; H01R 24/78; H02K 7/006

(57) ABSTRACT

An automotive vehicle includes road wheels and a power source configured to provide drive torque to the road wheels. The power source includes an internal combustion engine having an associated fuel level. The vehicle additionally includes an alternator coupled to the internal combustion engine and configured to generate power when the internal combustion engine is in a running state. The vehicle also includes an electric power receptacle electrically coupled to the alternator. The receptacle is configured to selectively electrically couple to an external device. The vehicle further includes a controller. The controller is configured to, in response to the internal combustion engine being in the running state, the receptacle being electrically coupled to an external device, and the fuel level falling below a calibrated threshold, stop the internal combustion engine.

### TECHNICAL FIELD

The present disclosure relates to automotive vehicles, and more particularly to a power generation and power receptacle system for an automotive vehicle.

### INTRODUCTION

Operators of automotive vehicles, particularly utility vehicles such as pickup trucks, may desire access to portable electric power for a variety of devices used outside the vehicle, including, but not limited to, power tools, lights, and mobile computing devices. While some vehicles may include one or more electric outlets, such outlets are typically provided in the cabin of the vehicle and thus may not be optimal for powering devices outside the vehicle. Moreover, extensive use of such outlets may risk draining the vehicle battery. Some operators may store a portable generator in a cargo portion of the vehicle in order to satisfy portable power needs; however, such generators tend to be heavy and bulky.

### SUMMARY

An automotive vehicle according to the present disclosure includes road wheels and a power source configured to provide drive torque to the road wheels. The power source includes an internal combustion engine having an associated fuel level. The vehicle additionally includes an alternator coupled to the internal combustion engine and configured to generate power when the internal combustion engine is in a running state. The vehicle also includes an electric power receptacle electrically coupled to the alternator. The receptacle is configured to selectively electrically couple to an external device. The vehicle further includes a controller. The controller is configured to, in response to the internal combustion engine being in the running state, the receptacle being electrically coupled to an external device, and the fuel level falling below a calibrated threshold, stop the internal combustion engine.

In an exemplary embodiment, the vehicle additionally includes an HMI, and the calibrated threshold is based on a first operator input to the HMI. The HMI may include a mobile device in wireless communication with the controller. The controller may be further configured to, in response to the receptacle being electrically coupled to an external device and the internal combustion being stopped, provide a prompt via the HMI and, in response to a second operator input to the HMI subsequent the prompt, start the internal combustion engine.

In an exemplary embodiment, the vehicle additionally includes an inverter electrically coupling the alternator to the receptacle.

In an exemplary embodiment, the vehicle additionally includes a truck bed having an enclosure, the receptacle being disposed in the enclosure.

A method of controlling a power system for a vehicle according to the present disclosure includes providing an automotive vehicle with a motive power source including an internal combustion engine, an electric power receptacle configured to provide electric power to an external device when the internal combustion is in a running state, and a controller in communication with the internal combustion engine and the electric power receptacle. The method additionally includes receiving, via the controller, a first signal, a second signal, and a third signal. The first signal indicates the internal combustion being in the running state, the second signal indicates an external device being coupled to the electric power receptacle, and the third signal indicates a fuel level associated with the internal combustion engine being below a calibrated threshold. The method further includes, in response to the first signal, second signal, and third signal being received, automatically stopping the internal combustion engine via the controller.

In an exemplary embodiment, the automotive vehicle includes an HMI, and the method additionally includes receiving an operator input via the HMI, with the calibrated threshold being calibrated based on the operator input. The HMI may include a mobile device in wireless communication with the controller, with the operator input including an operator input to the mobile device. The method may include, in response to the receptacle being electrically coupled to an external device and the internal combustion being stopped, automatically, via the controller, providing a prompt via the HMI and, in response to a second operator input to the HMI subsequent the prompt, automatically starting the internal combustion engine via the controller.

Embodiments according to the present disclosure provide a number of advantages. For example, systems and methods according to the present disclosure may provide power to devices external to the vehicle while maintaining adequate fuel for a subsequent drive cycle, thereby increasing customer satisfaction.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is an first view of a vehicle according to an embodiment of the present disclosure;

FIG. 2 is a second view of a vehicle according to an embodiment of the present disclosure;

FIG. 3 is a schematic representation of a vehicle according to an embodiment of the present disclosure; and

FIG. 4 is a flowchart representation of a method for controlling a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

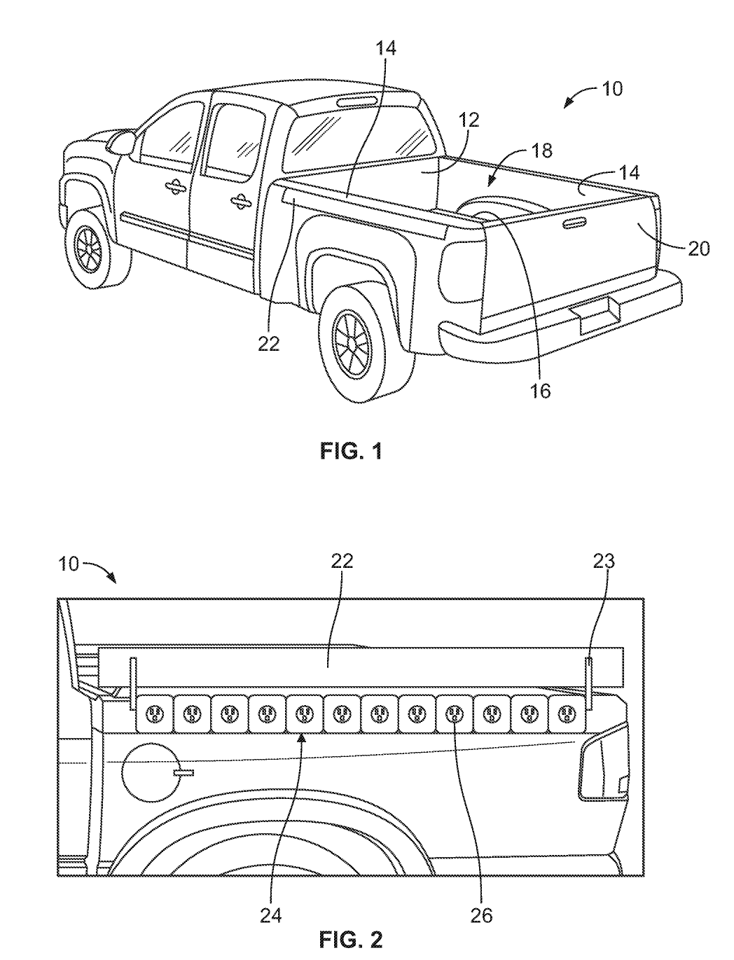

Referring now to FIGS. 1 and 2, a vehicle 10 according to the present disclosure is illustrated. The vehicle 10 has a cargo area 18 defined by a front wall 12, side walls 14, and a truck bed 16. While the vehicle 10 is shown as a pickup truck for illustrative purposes, it should be appreciated that other types of vehicles are considered within the scope of the present disclosure. The vehicle 10 also has a tailgate 20 that may be attached to the side walls 14 and/or the truck bed 16.

A panel 22 is disposed in the vicinity of the cargo area 18. In this embodiment, the panel 22 is disposed on an exterior portion of the cargo area 18; however, in other embodiments the panel 22 may be disposed in an interior portion of the cargo area 18.

The panel 22 is provided with a hinge assembly 23 for moving between a closed position, as illustrated in FIG. 1, and an open position, as illustrated in FIG. 2. When the panel 22 is in the open position, an operator may access a power box 24. In the illustrated embodiment the power box 24 is disposed between interior and exterior panels of the cargo area 18; however, in other embodiments the power box 24 may be disposed in a variety of locations as desired. The power box 24 includes one or more electric power receptacles 26. While depicted as standard U.S. power outlets, the power receptacles 26 may include any suitable power receptacle, including, but not limited to, other power outlet standards, USB ports, or a proprietary power socket. In addition, a storage compartment may also be provided proximate the power box 24 and likewise coverable by the panel 22.

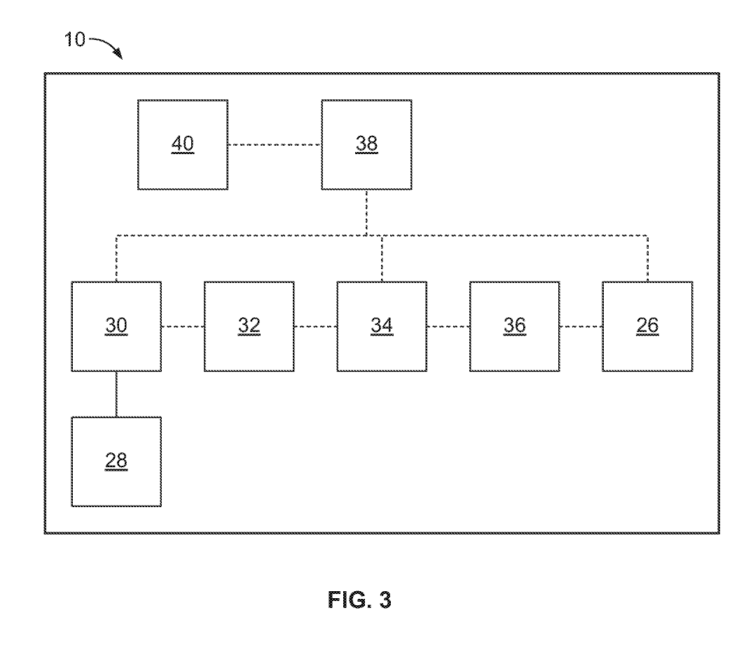

Referring now to FIG. 3, the vehicle 10 is illustrated schematically. The vehicle 10 is provided with a plurality of road wheels 28 and powertrain 30 configured to provide drive torque to the road wheels 28. The powertrain 30 includes an internal combustion engine. In an exemplary embodiment, the powertrain 30 is a conventional gasoline or diesel powertrain, with the internal combustion engine configured to provide drive torque to the road wheels 28 via a transmission. However, in other embodiments, the powertrain 30 is a hybrid electric powertrain, with the internal combustion engine configured to selectively charge a high voltage battery, which in turn is electrically coupled to a traction motor configured to provide drive torque to the road wheels 28. The internal combustion engine of the powertrain 30 is associated with a chemical fuel supply having a measurable fuel level.

The vehicle 10 is also provided with an alternator 32, which couples the internal combustion engine of the powertrain 30 to a battery 34. In embodiments with hybrid electric powertrains as discussed above, the battery 34 may be the high voltage battery for providing electric power to the traction motor. In other embodiments, the battery 34 may be a conventional starting-lighting-ignition (“SLI”) battery. The battery 34 has a measurable state of charge. The battery 34 is electrically coupled to one or more of the power receptacles 26 via an inverter 36. In an alternative embodiment, the alternator 32 may be directly electrically coupled to the inverter 36 to supply electric power to the power receptacles 26 while bypassing the battery 34.

The powertrain 30, battery 34, and power receptacles 26 are all in communication with or under the control of a controller 38. While depicted as a single unit, the controller 38 may include one or more additional controllers collectively referred to as a “controller.” The controller 38 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The vehicle 10 is also provided with a human-machine interface (HMI) 40. The HMI 40 provides an interface by which an operator may receive information from, or impart information to, the controller 38. According to various embodiments, the HMI 40 may include a multi-function touchscreen display, physical input devices such as buttons or knobs, or an application on a mobile device in wireless communication with the controller 38.

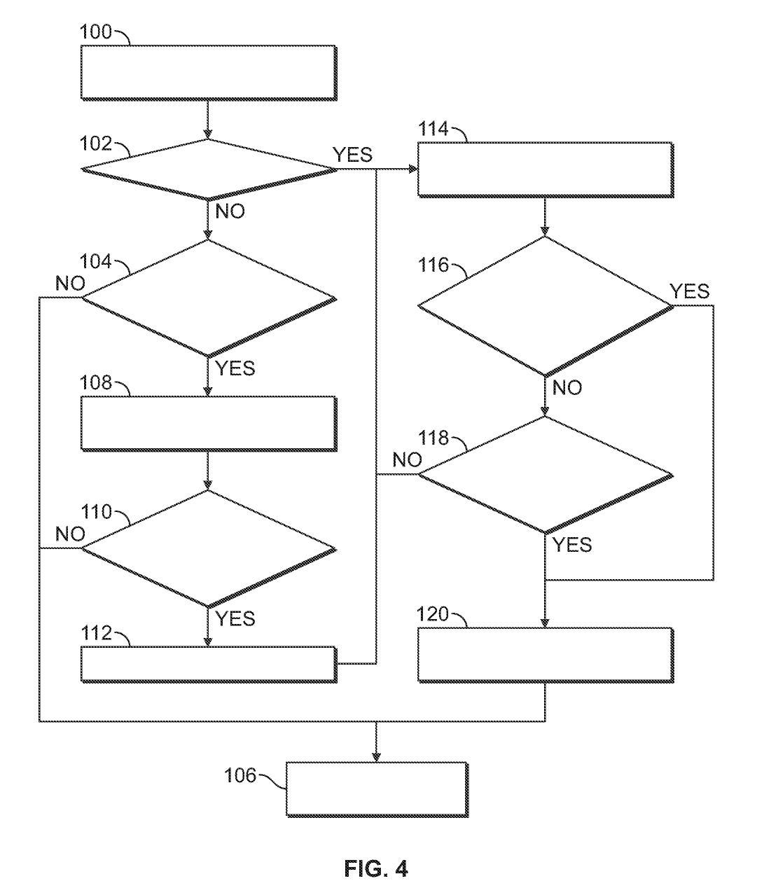

Referring now to FIG. 4, a method of controlling a vehicle according to the present disclosure is illustrated in flowchart form.

A device is inserted into a power receptacle, as illustrated at block 100. The power receptacle may one of the power receptacles 26 in the embodiment illustrated in FIGS. 1-3, or a similarly arranged power receptacle in other embodiments. The insertion of the device may be detected according to any known method, for example by monitoring current draw at the power receptacle, a physical switch proximate the power receptacle, or various other methods.

A determination is made of whether the internal combustion engine is running, as illustrated at operation 102. This determination and those following may be made by the controller 38 in the embodiment illustrated in FIGS. 1-3, or a similar controller in other embodiments.

If the determination of operation 102 is negative, i.e. the internal combustion engine is not running, then a determination is made of whether a battery SOC is above a cranking threshold, as illustrated at operation 104. The cranking threshold refers to a battery SOC required to start the engine. The cranking threshold may be a predefined value provided by the vehicle manufacturer, a dynamically-calculated parameter determined according to current vehicle conditions, or defined according to other means. The battery may be the battery 34 in the embodiment illustrated in FIGS. 1-3, or a similar battery in other embodiments.

If the determination of operation 104 is negative, i.e. the battery SOC is not above the cranking threshold, then an alert is transmitted to an operator, as illustrated at block 106. The alert may be transmitted via the HMI 40 in the embodiment illustrated in FIGS. 1-3, or a similar HMI in other embodiments. The alert may include an audio alert such as a chime, a visual alert such as an indicator icon, a text alert such as a notification on a mobile device, other type of alert, or combination thereof. The alert is configured to alert the operator that the engine may not be started to power the receptacle.

If the determination of operation 104 is positive, i.e. the battery SOC is above the cranking threshold, then the operator is prompted to enable a generator mode, as illustrated at block 108. The prompt may be transmitted via the HMI 40 in the embodiment illustrated in FIGS. 1-3, or a similar HMI in other embodiments. The prompt may include an audio alert such as a chime, a visual alert such as an indicator icon, a text alert such as a notification on a mobile device, other type of alert, or combination thereof. The prompt is configured to alert the operator that the engine may be started to power the receptacle, and to request a confirmation from the operator to start the engine.

A determination is then made of whether an operator activation input is received, as illustrated at operation 110. The operator activation input may be received via an HMI as discussed above, and may comprise, for example a spoken confirmation, selection of an icon, or other action indicative of an operator desire to start the engine.

If the determination of operation 110 is negative, i.e. no operator activation input is received, then an alert is transmitted to the operator as illustrated at block 106. The alert may be transmitted via an HMI as discussed above. The alert is configured to alert the operator that the engine may not be started to power the receptacle.

If the determination of operation 110 is positive, then the engine is automatically started, as illustrated at block 112.

Power is then provided to the receptacle, as illustrated at block 114. Likewise, if the determination of operation 102 is positive, power is provided to the receptacle at block 114.

A determination is made of whether a fuel level for the internal combustion engine is below a threshold, as illustrated at block 116. In an exemplary embodiment, the threshold is an operator-defined threshold indicating a desired fuel reserve level. In such embodiments, the operator may interact with the HMI to define a desired volume of fuel or driving distance to be reserved, and the threshold is determined according to the operator input. The operator may do so on a case-by-case basis, e.g. each time the engine is used to power the receptacle, or may provide a default value to be used in all such instances. In an alternative embodiment, the threshold may be a predefined value established by a manufacturer.

If the determination of operation 116 is negative, i.e. the fuel level is not below the threshold, then a determination is made of whether an operator shutoff input is received, as illustrated at operation 118. The operator shutoff input may be received via an HMI as discussed above, and may comprise, for example a spoken command, selection of an icon, or other action indicative of an operator desire to turn off engine.

If the determination of operation 118 is negative, i.e. no operator shutoff input is received, then control returns to block 114 and power is provided to the receptacle. The receptacle is thereby powered unless and until the fuel level falls below the threshold or an operator shutoff input is received.

If either the determination of operation 116 or the determination of operation 118 is positive, the engine is turned off as illustrated at block 120, and power transmission to the receptacle is discontinued.

An alert is then transmitted to the operator, as illustrated at block 106. The alert may be transmitted via an HMI as discussed above. The alert is configured to alert the operator that the engine has been stopped and the receptacle is no longer powered.

After the algorithm has been completed, the vehicle may be operated as usual, e.g. starting the engine for a subsequent drive cycle. In embodiments including an operator-definable fuel threshold, an operator may establish a lower threshold and begin the algorithm again.

While the above has been discussed largely with respect to a vehicle powered by a traditional gasoline-powered or diesel-powered internal combustion engine, embodiments contemplated within the scope of the present disclosure include vehicles powered by fuel cells or purely electric vehicles.

As may be seen, embodiments according to the present disclosure provides a system and method for providing power to devices external to the vehicle while maintaining adequate fuel for a subsequent drive cycle, thereby increasing customer satisfaction.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
road wheels;
a power source configured to provide drive torque to the road wheels, the power source including an internal combustion engine having an associated fuel level;
an alternator coupled to the internal combustion engine and configured to generate power when the internal combustion engine is in a running state;
an electric power receptacle electrically coupled to the alternator; the receptacle being configured to selectively electrically couple to an external device; and
a controller configured to, in response to the internal combustion engine being in the running state, the receptacle being electrically coupled to an external device, and the fuel level falling below a calibrated threshold, stop the internal combustion engine.

2. The automotive vehicle of claim 1, further comprising an HMI, wherein the calibrated threshold is based on a first operator input to the HMI.

3. The automotive vehicle of claim 2, wherein the HMI includes a mobile device in wireless communication with the controller.

4. The automotive vehicle of claim 2, wherein the controller is further configured to, in response to the receptacle being electrically coupled to an external device and the internal combustion being stopped, provide a prompt via the HMI and, in response to a second operator input to the HMI subsequent the prompt, start the internal combustion engine.

5. The automotive vehicle of claim 1, further comprising an inverter electrically coupling the alternator to the receptacle.

6. The automotive vehicle of claim 1, further comprising a truck bed having an enclosure, the receptacle being disposed in the enclosure.

7. A method of controlling a power system for a vehicle, the method comprising:
providing an automotive vehicle with a motive power source including an internal combustion engine, an electric power receptacle configured to provide electric power to an external device when the internal combustion is in a running state, and a controller in communication with the internal combustion engine and the electric power receptacle;
receiving, via the controller, a first signal indicating the internal combustion being in the running state, a second signal indicating an external device being coupled to the electric power receptacle, and a third signal indicating a fuel level associated with the internal combustion engine being below a calibrated threshold; and
in response to the first signal, second signal, and third signal being received, automatically stopping the internal combustion engine via the controller.

8. The method of claim 8, wherein the automotive vehicle includes an HMI, the method further comprising receiving an operator input via the HMI, wherein the calibrated threshold is calibrated based on the operator input.

9. The method of claim 8, wherein the HMI includes a mobile device in wireless communication with the controller, and wherein the operator input includes an operator input to the mobile device.

10. The method of claim 8, further comprising, in response to the receptacle being electrically coupled to an external device and the internal combustion being stopped, automatically, via the controller, providing a prompt via the HMI and, in response to a second operator input to the HMI subsequent the prompt, automatically starting the internal combustion engine via the controller.
